(19) United States
(12) Patent Application Publication
(10) Pub. No.: US 2017/0267372 A1
(43) Pub. Date: Sep. 21, 2017

(54) DRONE, IN PARTICULAR OF THE FLYING WING TYPE, PROVIDED WITH A MULTIFUNCTION SUPERSTRUCTURE ELEMENT

(71) Applicant: PARROT DRONES, Paris (FR)

(72) Inventors: Mael DONNARD, PARIS (FR); Frederic PIRAT, PARIS (FR); Henri SEYDOUX, PARIS (FR)

(73) Assignee: PARROT DRONES, Paris (FR)

(21) Appl. No.: 15/458,225

(22) Filed: Mar. 14, 2017

(30) Foreign Application Priority Data
Mar. 15, 2016 (FR) 16 52148

(51) Int. Cl. B64D 43/02; F21V 8/00; B64D 47/06; G01P 5/16; B64C 39/02; B64C 1/00

(52) U.S. Cl. CPC B64D 43/02; B64C 39/024; B64C 1/0009; B64D 47/06; G01P 5/16; G02B 6/0066; G02B 6/0013; G02B 6/005; B64D 47/08

(57) ABSTRACT

Disclosed are embodiments of a drone with a flattened tubular part protrudingly mounted on a module located on the fuselage of the drone, where the free distal end of the drone may also include a Pitot tube dynamic pressure front air intake. An internal duct may further connect the air intake to a pressure sensor mounted on the module. The tubular part may be mobile with respect to the module and may further include a means or mechanism for the mechanical coupling to a contractor mounted on the module. The tubular part may further include a light guide in light communication with a luminescent element mounted in the vicinity or at the level of the proximal end thereof. The tubular part may also include two sectionalized portions that are nested and in continuation of each other, where the base portion may be permanently linked to the module and a removable protruding portion may be located at the top base portion, which may include a front air intake and an internal duct.

### CROSS RELATED APPLICATIONS

This application claims priority to French patent application No. 16 52148 filed Mar. 15, 2016.

### TECHNICAL FIELD

The disclosed technology relates generally to motorized flying devices, such as drones.

### BACKGROUND

Exemplary drones may include fixed-wing drones, such as the “flying type” of the eBee drone model from SenseFly in Cheseaux-Lausanne, Switzerland, which is a professional land-mapping drone equipped with a vertical-view camera. Such a drone may be used in agronomy for the follow-up of agricultural crops. However, it should be noted that other exemplary drones may be applied, such as rotary-wind drones of quadricopters by way of example only. One example of such may include the Bebop drone of Parrot SA in Paris, France, which is a drone equipped with two front and vertical view cameras.

These exemplary drones may include a number of great functionalities by implementing a multitude of sensors and control loops for the piloting and control of the drone's trajectory. However, the complexity of these functionalities must be less apparent to the user so that user may easily focus on piloting the drone without having to care about the internal drone mechanisms.

Thus, it is important that a simple implementation of the drone be taken in account for designing the drone and its ergonomics. On the other hand, especially for drones of the flying wing type, such as those that fly at high speeds (e.g., typically up to 80 km/h), the aerodynamic factor may be another important characteristic of the drone. Indeed, it is advisable to reduce the most possible amount of drag introduced by superstructure elements that have no aerodynamic role, such as external sensors, control buttons, accessories, etc.

Other important constraints must also be taken into account, such as drone mass (e.g., desire for constitutive elements to be as light as possible) and the robustness thereof (e.g., important consideration considering the high risk of impact due to the drone's high speeds). It will be noted that in this respect, low mass and high robustness are generally contradictory requirements, which often involve restricted design choices.

### BRIEF SUMMARY OF EMBODIMENTS

According to various embodiments, disclosed are drones with particular superstructure elements to allow simplified ergonomic design for the user, maximum robustness to impact potential falls, and integration of functional items with minimal effect on the overall aerodynamic performance of the drone.

According to some embodiments, a fuselage and a superstructure element may include a flattened tubular part that may be adapted to be mounted in a protruding manner with respect to the fuselage of the drone. This tubular part may include: a proximal end including a means or mechanism for the mounting the drone; a free distal end with a Pitot tube dynamic pressure front air intake; an internal duct in fluid communication with the front air intake, where this duct has an orifice formed on the proximal end and adapted to be connected to a pressure sensor mounted on a module configured in the fuselage of the drone; and a light guide in light communication with a luminescent element mounted in the vicinity or at the level of the proximal end of the tubular part.

Characteristically, embodiments may include a tubular part that is mobile with respect to the fuselage between two predetermined positions. The tubular part may include a means or mechanism at the proximal end of the tubular part for the for the mechanical coupling onto a contractor mounted on the module, where the coupling means may be configured to activate the contractor between two different states that correspond to the two respective positions.

According to various embodiments:
the tubular part may be partially mobile in vertical translation between two predetermined positons along a direction normal to the fuselage in the proximal end region of the tubular part;
the tubular part may include two portions separately nested into each other in continuation of each other, with a base portion permanently linked to the module and with a means or mechanism for the mechanical coupling to the contactor, and a removable protruding portion located on top of the base portion with a front air intake and the internal duct;
the base portion and the protruding portion cooperate by nesting with a functional adjustment to allow their mutual separation in case of excessive internal stress that may occur at the protruding portion;
the base portion may extend partially inside the module and partially outside the module, where the protruding portion may extend completely outside the module and the base portion being extended completely inside the fuselage;
the base portion may include a support for the luminescent element, such that the protruding portion can be a portion made of a translucent or transparent material forming a light guide, where the material forming the base portion is different; and
the orifice of the internal duct that opens from the tubular part to the inner volume of the module at the level of the link between the protruding portion and the base portion.

Other features and aspects of the invention will become apparent from the following detailed description, taken in conjunction with the accompanying drawings, which illustrate, by way of example, the features in accordance with embodiments of the invention. The summary is not intended to limit the scope of the invention, which is defined solely by the claims attached hereto.

### BRIEF DESCRIPTION OF THE DRAWINGS

The technology disclosed herein, in accordance with one or more various embodiments, is described in detail with reference to the following figures. The drawings are provided for purposes of illustration only and merely depict typical or example embodiments of the disclosed technology. These drawings are provided to facilitate the reader's understanding of the disclosed technology and shall not be considered limiting of the breadth, scope, or applicability thereof. It should be noted that for clarity and ease of illustration these drawings are not necessarily made to scale.

FIG. 1 illustrates an overall view showing a fixed-wing drone flying in the air under the control of a remote-control equipment according to one particular embodiment.

FIG. 2 is a perspective view of a front portion of a drone with an emerging portion of the superstructure element according to one particular embodiment.

FIG. 3 is a perspective view of an internal module of a drone with a superstructure element according to one particular embodiment.

FIG. 4 is a lateral view of a superstructure element according to one particular embodiment.

FIG. 5 is a lateral sectional view of a superstructure element with different elements of the front portion of the internal module of the drone according to one particular embodiment.

The figures are not intended to be exhaustive or to limit the invention to the precise form disclosed. It should be understood that the invention can be practiced with modification and alteration, and that the disclosed technology be limited only by the claims and the equivalents thereof.

### DETAILED DESCRIPTION OF THE EMBODIMENTS

The following description is not to be taken in a limiting sense, but is made merely for the purpose of describing the general principles of the disclosed embodiments. The present embodiments address the problems described in the background while also addressing other additional problems as will be seen from the following detailed description. Numerous specific details are set forth to provide a full understanding of various aspects of the subject disclosure. It will be apparent, however, to one ordinarily skilled in the art that various aspects of the subject disclosure may be practiced without some of these specific details. In other instances, well-known structures and techniques have not been shown in detail to avoid unnecessarily obscuring the subject disclosure.

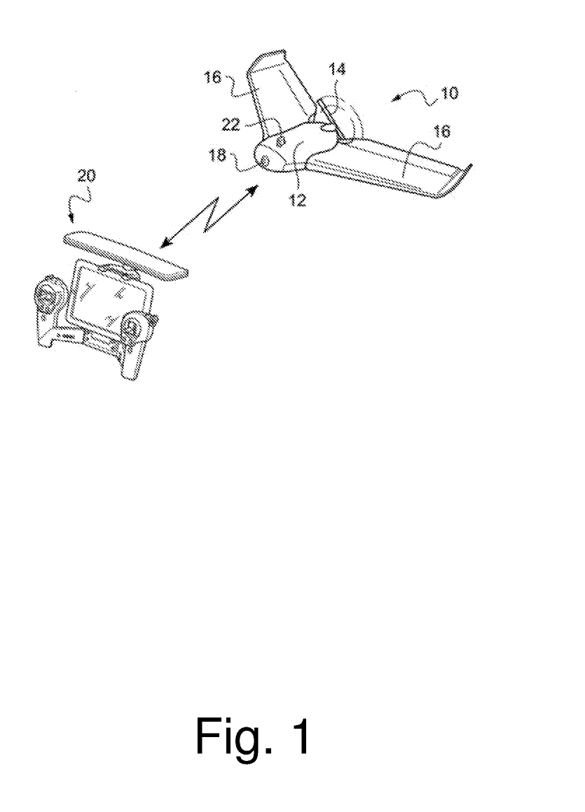

FIG. 1 illustrates a drone 10, which may be a fixed-wing drone such as the eBee model of SenseFly by way of example only. This drone 10 may include a fuselage 12 in the rear portion of the drone, where the rear portion may include a propeller 14 and two wings 16. The two wings 16 may be possibly integrated with the fuselage 12. Additionally, the front camera 18 may allow images to be obtained of the scenes towards which the drone 10 progresses.

The drone 10 may be piloted by a remote control apparatus 20 provide with a touch screen displaying the image captured by the camera 18, as well as various piloting commands at the user's disposal. The remote control apparatus 20 may be provided with a means or mechanism to establish a radio link with the drone 10. For example, the Wi-Fi (IEEE 802.11) local network type may be utilized for the bidirectional exchange of data from the drone 10 to the remote control apparatus 20. In particular, such a local network type may be used for the transmission of the image captured by the camera 18, and for sending piloting commands from the remote control apparatus 20 to the drone 10.

Additionally, the drone 10 may also include a superstructure element 22 at the front, top portion of the drone 10. More detail will be explained below with respect to the superstructure element 22.

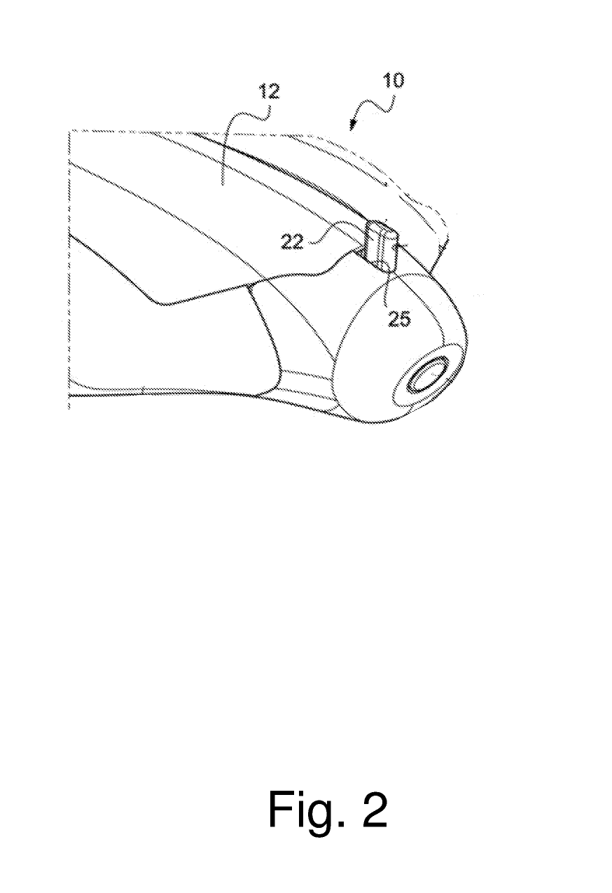

As illustrated in FIG. 2, the drone 10 may include a superstructure element 22 at the front portion of the drone 10 that protrudes in the radial direction, which may be perpendicular to the fuselage 12. This superstructure element 22 may be external in the form of a flattened tubular part extending approximately in a median longitudinal plane of the fuselage 12, with the narrowest side-facing the direction of the progression of the drone 10, so as to introduce the lowest drag possible.

As illustrated, there may be an opening 25 so that the superstructure element 22 may protrude out into the environment.

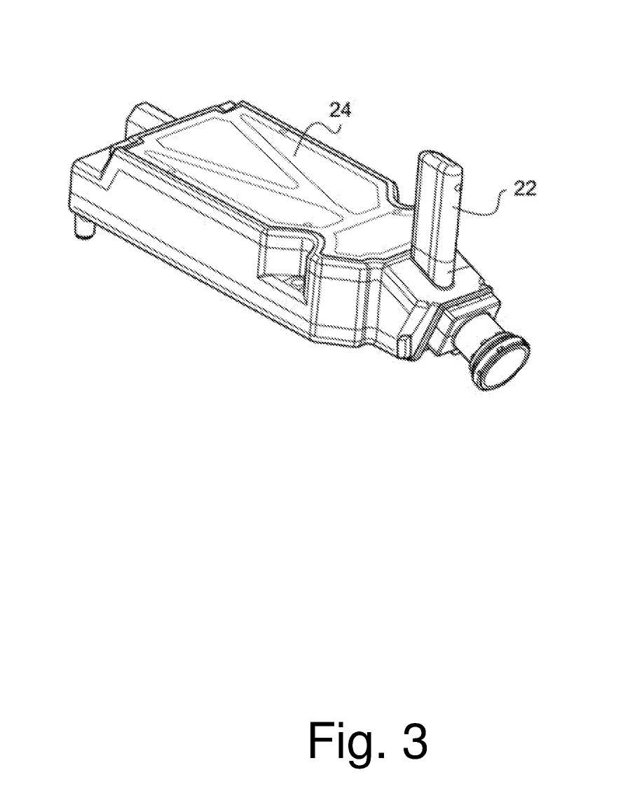

FIG. 3 illustrates the main electronic module 24 of the drone 10, which may be extracted from the fuselage, such that the fuselage houses and provides a protective envelope to the main electronic module 24.

The superstructure element 22 may extend from the electronic module 24, which may constitute as an extension. When the electronic module 24 is enclosed in the fuselage, only the upper portion of the element 22 may protrude through an opening (not shown here) of the fuselage. The lower portion of the superstructure element 22 and totality of the electronic module 24 may remain enclosed in the fuselage and thus protected.

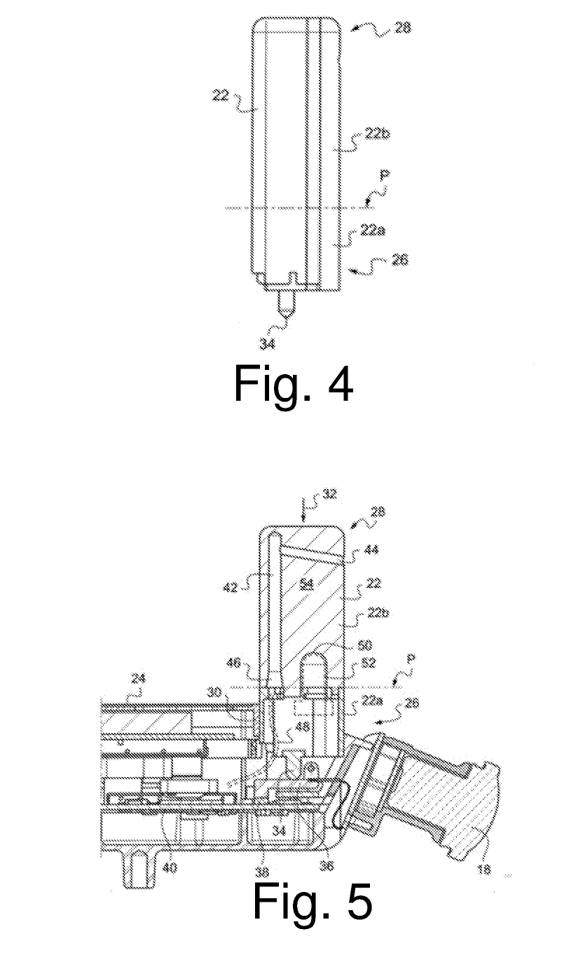

Both FIGS. 4 and 5 show in more detail of the structure of the superstructure element 22. More specifically, FIG. 4 illustrates the different elements of the front portion of the superstructure element 22. The superstructure element 22 may include a proximal end 26 and a free distal end 28 that may correspond to the emerging portion that protrudes above the fuselage of the drone. Advantageously, the superstructure element 22 may be formed of two portions that are nested into each other and in continuation of each other, where a base portion 22a on the proximal side may be connected to electronic module. Additionally, a removable protruding portion 22b may be on the distal side that is located on top of the base portion 22a of the proximal end 26. These two portions 22a and 22b may extend on either side of a plane, p, and may be nested into each other with a functional adjustment that may allow for their mutual separation in case of excessive external stress of the protruding portion of the superstructure element 22. For example, in case of an impact of the drone, the superstructure element 22, which protrudes out of the fuselage, may be able to be ejected and replaced if damaged. The base portion 22a that is located inside the fuselage may remain in place with the electronic module 24 so that there will not be any damage in the instance of impact.

In some embodiments, as illustrated in FIG. 5, the base portion 22a may be mounted on the electronic module 24 in a guiding orifice 30 to allow the displacement in vertical translation along a direction perpendicular to the fuselage. For example, the superstructure element 22 may be displaced under the effect of a pressure (arrow 32) exerted on the distal end 28 by the user. It should be noted that the vertical direction may be understood in a radial plane with respect to the main axis of the drone and of the electronic module 24.

Furthermore, the base portion 22a at the proximal end 26 may be provided in a lower portion with a pusher element 34 (also illustrated in FIG. 4) bearing on an articulated lever 36 where its end pushes an electrical contractor 38 mounted on the printed circuit board 40 of the module 24. A pressure (arrow 32) on the distal end 28 of the superstructure element 22 will then have the effect to actuate the electrical contractor 38. This will release the pressure and return the electrical contractor 38 back to its initial resting position. In some examples, the return to the initial resting position is done by an elastic return means, which are provided to push the superstructure element 22 upward into the guiding orifice 30 and allow the actuation of the contractor 40. By way of example only, the contractor 40 may be a fugitive type and this return to the initial resting position may occur for the duration of the pressure on the end of the superstructure element 22.

The protruding portion 22b may include an internal duct 42 extending over its length and may end on the distal side by the front air intake 44 and on the proximal side of the outlet 46. By way of example, the front air intake 44 may face the direction of the progress of the drone. It may be located on the portion of the superstructure element 22 that emerges from the fuselage, and in the region of the distal end 28 that allows for it to be located remote from the surface of the fuselage, as also illustrated in FIG. 2.

The front air intake 44 may be a Pitot tube dynamic pressure front air intake by way of example only. The pressure collected at the front air intake 44 may be transmitted through the internal duct 42 to the outlet 46. The pressure may then proceed from a flexible link 48 to the pressure sensor mounted on the printed circuit board 40, where another sensor may be mounted for measuring the static pressure. The differential between static pressure and dynamic pressure may provide the speed of the drone with respect to the air (relative wind). It will be noted that to avoid the measurement errors linked to the vibrations in flight, it may be desirable to limit the mobility of the superstructure element 22, which may carry the air intake to the Pitot tube.

The protruding portion 22b of the superstructure element 22 may include a cavity 50 on the side on which it is nested to the base portion 22a. The cavity 50 may house the head of an electroluminescent diode 52 whose base is mounted and supported by the base portion 22a. The material 54 of the protruding portion 22b may be transparent or translucent material, such as polycarbonate by way of example only. This may allow for the protruding portion 22b to play the role of a light guide for the superstructure element 22. The activation of the electroluminescent diode 52 may illuminate the protruding portion 22b and the portion thereof that emerges from the fuselage, whereas the electroluminescent diode 52 remains housed in the fuselage to be protected.

The superstructure element 22 may allow for the advantageous combination of several functions, which may be for both the user and the design of the drone. First, the superstructure element 22 may allow the drone to operate by actuation of the protruding portion 22b. Without it, it will be necessary to turn the drone upside down to actuate the switch or to open the door, as is the case with present drone.

The starting of the drone may occur with the application of pressure (arrow 32) on the free end of the superstructure element 22, which has the effect of actuating the contractor 38. This may cause the processor of the electronic module 24 to relay a signal that will trigger the circuits awake, such as switching on the power supply, etc. and the checking of all the conditions needed before it takes off into the air. Likewise, after the landing, the user may simply need to press again on the free end of the superstructure element 22 to generate an interruption that transmits to the processor the command to switch off the circuits after the processor has ensured that the conditions are satisfied for such a command (e.g., null altitude and speed, etc.). On the contrary, if the superstructure element 22 is stressed in flight, for example, after having touched a tree, the drone may be able to distinguish that such an event is an unexpected actuation and that this is not the time to cause the immediate stopping of the drone.

In some embodiments, the function of the light guide may provide the user with a visual feedback about the state of the drone by switching on/off the electroluminescent diode located inside the fuselage but visible from the outside through the light guide 54. By way of example, there may be different colors that indicate different functions or states of the drone (powered off, ready for takeoff, operation anomaly, etc.).

Finally, the front air intake 44 may be arranged in the most distal region of the emerging part of the superstructure element 22, which may be remote from the fuselage. This may ensure excellent sensing of the dynamic pressure in a laminar flow that is not disturbed the effects of turbulences and of the limit layer present at the surface of the drone fuselage.

It will be noted that these various advantages are obtained with a superstructure element 22 that has only a small drag, which is very little disturbance while simultaneously being robust and light-weight.

Additionally, the superstructure element 22, which remains enclosed in the mechanical structure of the fuselage, allows for the module to have access to the environment for three main purposes: i) the switching on/off of the circuits of the drone; ii) delivery of visual information to the user about the drone state; and iii) providing a Pitot tube dynamic pressure front air intake in order to measure the air speed of the drone when in flight. The superstructure element 22 allows these interactions of the electronic nmodule 24 with the environment without the user having to manipulate the electronic module, which remains carefully confined and protected while simultaneously allowing for these exemplary three functions to be available from the outside of the drone.

Finally, the protruding portion 22b with respect to the base portion 22a mounted on the electronic module 24 makes it so that even in the case of violent impact, the most fragile elements still remain protected. These fragile elements may include: electroluminescent diode 52, link 48 between the internal duct 42 communicating with the front air intake 44 and the pressure sensor mounted on the printed circuit board 40, the system of mobile support and guiding section of the base portion 22a in the orifice 30, and the system of operation of the contractor 38. These elements may all be directly or indirectly connected to the base portion 22a but not to the removable protruding portion 22b, as these exemplary elements all remain located inside the fuselage 12 in which they are protected. In case of impact, only the protruding portion 22b, which may only be a one-piece molded part by way of example, which can be easily replaced.

Additionally, by way of example only, a front camera 18 may be located at the proximal end. This front camera 18 may obtain images of the scenery of the environment in which the drone progresses. Additionally, the front camera may be commanded by a user utilizing the same remote control apparatus used to maneuver and pilot the drone.

Various embodiments have been described with reference to specific example features thereof. It will, however, be evident that various modifications and changes may be made thereto without departing from the broader spirit and scope of the various embodiments as set forth in the appended claims. The specification and figures are, accordingly, to be regarded in an illustrative rather than a restrictive sense.

Although described above in terms of various example embodiments and implementations, it should be understood that the various features, aspects and functionality described in one or more of the individual embodiments are not limited in their applicability to the particular embodiment with which they are described, but instead may be applied, alone or in various combinations, to one or more of the other embodiments of the present application, whether or not such embodiments are described and whether or not such features are presented as being a part of a described embodiment. Thus, the breadth and scope of the present application should not be limited by any of the above-described example embodiments.

Terms and phrases used in the present application, and variations thereof, unless otherwise expressly stated, should be construed as open ended as opposed to limiting. As examples of the foregoing: the term “including” should be read as meaning “including, without limitation” or the like; the term “example” is used to provide illustrative instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, may be combined in a single package or separately maintained and may further be distributed in multiple groupings or packages or across multiple locations.

Additionally, the various embodiments set forth herein are described in terms of example block diagrams, flow charts, and other illustrations. As will become apparent to one of ordinary skill in the art after reading this document, the illustrated embodiments and their various alternatives may be implemented without confinement to the illustrated examples. For example, block diagrams and their accompanying description should not be construed as mandating a particular architecture or configuration.

While various embodiments of the disclosed technology have been described above, it should be understood that they have been presented by way of example only, and not of limitation. Likewise, the various diagrams may depict an example architectural or other configuration for the disclosed technology, which is done to aid in understanding the features and functionality that can be included in the disclosed technology. The disclosed technology is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement the desired features of the technology disclosed herein. Also, a multitude of different constituent module names other than those depicted herein can be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the disclosed technology is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the disclosed technology, whether or not such embodiments are described and whether or not such features are presented as being a part of a described embodiment. Thus, the breadth and scope of the technology disclosed herein should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A drone comprising:
a fuselage;
a superstructure element comprising a flattened tubular part adapted to be mounted in a protruding manner with respect with the fuselage of the drone, wherein the tubular part comprises:
a proximal end comprising a mechanism for mounting the drone;
a free distal end with a Pitot tube dynamic pressure front air intake;
an internal duct in fluid communication with the Pitot tube dynamic pressure front air intake adapted to be connected to a pressure sensor mounted on a module on the fuselage of the drone; and
a light guide in light communication with a luminescent element mounted in a vicinity or at a level of the proximal end of the tubular part such that the tubular part is in a mobile part with respect to the fuselage between two predetermined positions,
wherein the tubular part comprises a mechanical coupling mechanism at the proximal end to attach onto a contractor mounted on the module, where the mechanical coupling mechanism is adapted to activate the contractor between two different states that correspond to two respective positions.

2. The drone of claim 1, wherein the mobile part is in vertical translation between two predetermined positions along a direction normal near the proximal end of the fuselage.

3. The drone of claim 1, wherein the tubular part comprises a base portion and a removable protruding portion separately nested into each other such that the base portion is permanently linked to the module with a carrying mechanism to be mechanically coupled to the contractor, and the removable protruding portion is located on top of the base portion which includes a front air intake and an internal duct.

4. The drone of claim 3, wherein the base portion and the removable protruding portion cooperate by nesting with a functional adjustment so that they are separated when excessive external stress is present at the protruding portion.

5. The drone of claim 3, wherein the base portion extends partially inside the module and partially outside the module, and the removeable protruding portion extends completely outside the module.

6. The drone of claim 5, wherein the base portion extends completely inside the fuselage.

7. The drone of claim 3, wherein the base portion comprises a support for the luminescent element.

8. The drone of claim 7, wherein the protruding portion is a portion made of a translucent or transparent material to form a light guide that is made of a different material from the base portion.

9. The drone of claim 3, wherein the internal duct comprises an orifice that opens from the tubular part to an inner volume of the module at a level of a link between the base portion and the removable protruding portion.
